(19) United States
(12) Patent Application Publication
(10) Pub. No.: US 2024/0161717 A1
(43) Pub. Date: May 16, 2024

(54) TUNER WITH THE POSSIBILITY OF RESTORING THE PLAY POSSIBLY PRESENT BETWEEN THE INVOLUTE SCREW AND THE GEAR WHEEL MESHING THE SAME

(71) Applicant: ALESSI TUNING MACHINES, Luino (VA) (IT)

(72) Inventor: Nicolò ALESSI, Luino (VA) (IT)

(21) Appl. No.: 18/552,089

(22) PCT Filed: Sep. 14, 2021
(86) PCT No.: PCT/IT2021/050278

§ 371 Date: Sep. 22, 2023

(30) Foreign Application Priority Data
Jun. 10, 2021 (IT) 102021000015203

(51) Int. Cl. G10D 3/14; G10D 1/08

(52) U.S. Cl. CPC G10D 3/14; G10D 1/08

(57) ABSTRACT

Disclosed is a tuner for tensioning a string of a plucked chordophone musical instrument. The tuner differs from the known tuners in that the seat obtained in the plate and intended to accommodate the support slab of the involute screw is shaped so as to allow, if necessary, a translation of the slab with respect to the plate so as to move the involute screw towards the gear wheel which meshes it, orthogonally to the rotation axes thereof. Advantageously, it is thus possible to restore any possible undesirable play present between the involute screw and the gear wheel without having to rotate the latter about its axis.

### FIELD OF APPLICATION OF THE INVENTION

The present invention finds application in the field of plucked string musical instruments (also known as “chordophones”), such as guitars. More precisely, the present invention relates to musical instruments of the aforesaid type including, for each string, a “tuner” (also known as “tuning machine”). With reference, by way of example, to a classical guitar, the tuners are placed at the end portion of the neck (commonly known as “headstock”) opposite to the sound box and comprise a helical cylindrical gear wheel meshing with an involute screw (also known as “worm gear”).

The present invention relates, in particular, to a tuner integrating a system for restoring (intended as “eliminating”) any play possibly and undesirably present between the two aforementioned gear members. Incidentally and for the avoidance of doubt, “play” in the coupling between the helical cylindrical gear wheel and the involute screw of a tuner means a space between two surfaces opposed to each other of the two aforesaid gear members respectively, which, conversely, should be in contact. Said play may be caused, by way of explanation, by a failure to respect the tolerances in the production of the gear members or it may be formed by wear as a consequence of the use of the tuner.

### Overview of the Prior Art

The presence of play between the helical cylindrical gear wheel and the involute screw of a tuner is an issue for a musician when using the string instrument thereof, since said play compromises the tuning of the instrument.

To eliminate the play, the musician is forced to rotate, by means of a so-called “button”, the involute screw of the tuner which has said play. This operation, however, may further compromise the tuning of the instrument.

### OBJECTS OF THE INVENTION

It is the object of the present invention to overcome the aforesaid drawbacks by indicating a tuner in which the play possibly present between the helical cylindrical gear wheel and the involute screw may be restored without having to rotate the involute screw about its axis.

### SUMMARY AND ADVANTAGES OF THE INVENTION

It is the object of the present invention a tuner for tensioning a string of a plucked chordophone musical instrument, said tuner comprising:
a first support structure (commonly known as “plate”) connectable to a neck of said musical instrument, said first support structure including a first through hole;
an involute screw;
a second support structure connected to said first support structure, said involute screw being connected to said second support structure so as to be forced to rotate, with respect to said second support structure, about a first axis coincident with a longitudinal axis of said involute screw;
a knob (commonly known as “button”) integrally connected to said involute screw,
said knob being graspable by a person to rotate said involute screw about said first axis;
a flanged and externally threaded bush, i.e., a bush including:
   an externally threaded tubular side wall extending from a first end to a second end opposite to said first end;
   a first cavity delimited by said tubular side wall;
   a first opening to access said cavity,
   said first opening being at said first end;
   a second opening to access said first cavity, said second opening being opposite to said first opening and being at said second end;
   a flange comprising a second through hole,
   said flange being connected to said tubular side wall at said first end so that said second hole communicates with said first opening so that said first cavity is also accessible from said second hole, said tubular side wall having a length (understood as the distance between
said first and second ends thereof) greater than the depth of said first hole
and crossing said first support structure at said first hole, so as to be partially accommodated in said first hole, said flange being of a size such as and/or having a shape such as not to penetrate into said first hole,
said flange abutting against said first support structure so that:
   said flange and said second end lie on opposite sides with respect to said first support structure
and
   said tubular side wall protrudes, for a segment thereof, from said first support structure on the opposite side with respect to said flange,
said flange and said second support structure, together with said involute screw, lying on the same side with respect to said first support structure;
a first tightening element, preferably a “nut”, including a second threaded cavity at which said first tightening element is reversibly screwable on said tubular side wall starting from said second end,
said first tightening element being reversibly screwed on said tubular side wall at said segment thereof protruding from said first support structure, so as to abut against said first support structure, so as to determine a tightening of said first support structure between said flange and said first tightening element,
said tubular side wall having a length such that a portion of said segment of said tubular side wall protruding from said first support structure protrudes beyond said first tightening element. The tubular side wall of the bush thus has a length greater than the sum of the depth of the first hole and the depth of the second cavity (i.e., the thickness of the first tightening element), said tightening of said first support structure between said flange and said first tightening element integrally connecting said bush to said first support structure.

Incidentally, asserting that the first tightening element is reversibly screwable on the tubular side wall of the bush means that said element is screwable onto said wall and it is unscrewable from the latter for an indefinite number of times. Similarly, asserting that the tightening element is reversibly screwed on the tubular side wall of the bush means that said element is unscrewable from said wall and it is re-screwable onto the latter for an indefinite number of times;
a helical cylindrical gear wheel;
a stem including a first end and a second end opposite to said first end thereof,
said stem being integrally connected to said gear wheel at the first end thereof, so that a longitudinal axis of said stem coincides with a rotation axis of said gear wheel (i.e., an axis orthogonal to the latter and crossing the center thereof if said wheel was outlined with a circle),
said stem having a length (understood as the distance between said first and second ends thereof) greater than that of said tubular side wall and crossing said bush at said second hole (of said flange) and at said first cavity, so as to be partially accommodated in said first cavity,
said gear wheel being of a size such as and/or having a shape such as not to penetrate into said second hole, and preferably neither into said first cavity, said gear wheel abutting against said flange (directly or, preferably, with the interposition of a washer, preferably a metal one) so that:
   said gear wheel and said second end of said stem lie on opposite sides with respect to said first support structure and
   said stem protrudes for a segment thereof from said second end of said tubular side wall (i.e., on the opposite side with respect to said flange),
said stem being accommodated in said first cavity so as to be forced to rotate, with respect to said bush, about a second axis coincident with said longitudinal axis of said stem (and consequently with said rotation axis of said gear wheel) and orthogonal to said first axis;
a second tightening element, preferably a “roller”, including a third cavity in which said segment of said stem protruding from said bush is at least partially accommodated,
said second tightening element being integrally, and preferably reversibly (for example by means of a pin), connected to said stem so as to abut against said bush (directly or, preferably, with the interposition of a washer, preferably a metal one) at said second end of said tubular side wall, so as to prevent any translation between said stem, together with said gear wheel, and said bush,
said involute screw and said gear wheel being connected to said first support structure by means of said second support structure and said bush, respectively, so that said involute screw meshes with said gear wheel so that a rotation of said involute screw about said first axis determines a rotation of said gear wheel, together with said stem and said second tightening element, about said second axis,
said string being preferably reversibly connectable to said second tightening element so that, when said string is connected to said second tightening element, a rotation of said second tightening element about said second axis may tension said string.
Incidentally, asserting that the second tightening element is reversibly connected to the stem means that said element is disconnectable from the stem and reconnectable to the latter for an indefinite number of times.
Similarly, asserting that a string is reversibly connectable to the second tightening element means that said string is connectable to said tightening element and disconnectable from the latter an indefinite number of times,
   in which, according to the invention, said second support structure comprises a third through hole,
said second support structure overlapping said first support structure so that said third hole communicates with said first hole, so that said first hole (of said first support structure) and said second cavity (of said first tightening element) are accessible from said third hole (of said second support structure),
said third hole having a width such that and/or a conformation such that said second support structure may be crossed, at said third hole, by said tubular side wall but not by said flange,
said tubular side wall having a length greater than the sum of the depth of said first hole, the depth of said third hole and the depth of said second cavity (i.e., the thickness of the first tightening element,
said tubular side wall crossing not only said first support structure at said first hole, but also said second support structure at said third hole, so as to be partially accommodated also in said third hole,
said flange abutting against said first support structure with the interposition of said second support structure (i.e., the latter is partially interposed between said flange and said first support structure) so that:
   said flange and said second end of said bush lie on opposite sides not only with respect to said first support structure but also with respect to said second support structure
and
   the fact that said first tightening element is reversibly screwed on said tubular side wall so as to abut against said first support structure determines a tightening of said second support structure between said flange and said first support structure,
   said tightening of said second support structure between said flange and said first support structure integrally connecting said second support structure to said first support structure,
said tuner comprising linear guiding means forcing said second support structure, together with said involute screw, to translate with respect to said first support structure so that said involute screw translates towards or away from said gear wheel orthogonally to said first and second axis, so that, whenever a play is undesirably present between said involute screw and said gear wheel:
   following an unscrewing of said first tightening element from said tubular lateral wall, so as to loosen said tightening of said second support structure between said flange and said first support structure, said involute screw is translatable towards said gear wheel, in accordance with (i.e., “as required by”) said guiding means, so as to eliminate said play,
and
   after eliminating said play, said second support structure is integrally reconnectable to said first support structure by re-screwing said first tightening element on said tubular side wall so that said first tightening element returns to abut against said first support structure, redetermining said tightening of said second support structure between said flange and said first support structure,
said third hole having such a width and/or a such a conformation to be communicating with said first hole regardless of the position of said second support structure with respect to said first support structure according to said guiding means. The second support structure is thus translatable with respect to the first support structure, in accordance with the guiding means, even though it is crossed by the bush.

Incidentally, the first tightening element is unscrewable from the tubular side wall of the bush until it abuts against the second tightening element. The first tightening element is thus unscrewable from the tubular side wall of the bush without having to remove the second tightening element from the stem by virtue of the fact that the second tightening element abuts against the bush and the latter has a length greater than the sum of the depth of the first hole, the depth of the third hole and the depth of the second cavity, so as to protrude beyond the first tightening element.

In light of the foregoing, so as to allow the restoring of the play possibly and undesirably present between the involute screw and the gear wheel, the second support structure is solidly, but also reversibly, connected to the first support. The second support structure is thus movable, in accordance with the guiding means, with respect to the first support structure, and it is reconnectable to the latter for an indefinite number of times.

In light of the features listed above, the tuner of the invention allows to eliminate the play possibly present between the helical cylindrical gear wheel and the involute screw without having to rotate the latter, but by moving the involute screw towards the gear wheel.

Other innovative features of the present invention are disclosed in the description below and referred to in the dependent claims.

According to an aspect of the invention, said guiding means comprise a first seat obtained in said first support structure and in which said second support structure is accommodated at least at a portion thereof, said first seat and said portion of said second support structure accommodated in said first seat being shaped so that said second support structure, together with said involute screw, due to the effect of said at least partial accommodation in said first seat, is forced to translate, with respect to said first support structure, so that said involute screw moves towards, or away from, said gear wheel, orthogonally to said first and second axis.

According to this aspect of the invention, the guiding means are “integrated” in the first support structure (i.e., they are not a “foreign” component to the tuner).

According to another aspect of the invention, said first hole being obtained in said first support structure at said first seat, said third hole being obtained in said second support structure at said portion of the latter accommodated in said first seat.

According to another aspect of the invention, said guiding means comprise a second seat obtained in said second support structure and in which said flange is accommodated at least at a portion thereof,
said second seat and said portion of said flange accommodated in said second seat being shaped so that said second support structure, together with said involute screw, due to the effect of said at least partial accommodation of said flange in said second seat, is forced to translate with respect to said first support structure so that said involute screw translates towards or away from said gear wheel, orthogonally to said first and second axes.

According to this aspect of the invention, the guiding means are “integrated” in the second support structure (i.e., they are not a “foreign” component to the tuner).

For the avoidance of doubt, the aforesaid second seat may be either made alternatively or in addition to the aforesaid first seat (as guiding means of the second support structure with respect to the first support structure).

According to another aspect of the invention, said first hole is shaped so as to allow a translation to said bush exclusively parallel to said second axis.

According to another aspect of the invention, the tuner comprises elastic means at least partially interposed between said first and second support structures so as to exert a force tending to translate said second support structure, in accordance with said guiding means, with respect to said first support structure moving said involute screw towards said gear wheel.

Advantageously, according to this aspect of the invention, whenever it is necessary to remove a play between the involute screw and the gear wheel, after having loosened the tightening of the second support structure between the flange and the first support structure, the involute screw tends to “spontaneously” move towards the gear wheel due to the action of the elastic means (comprising, for example, a helical spring which works in traction or compression).

According to another aspect of the invention, the tuner comprises a linear actuator integrally connected to said first and second support structures so as to exert a force tending to translate said second support structure, in accordance with said guiding means, with respect to said first support structure moving said involute screw towards said gear wheel, said actuator being operable by a user of said tuner.

Advantageously, according to this aspect of the invention (alternatively or in addition to the previous aspect), whenever it is necessary to remove a play between the involute screw and the gear wheel, after having loosened the tightening of the second support structure between the flange and the first support structure, the involute screw may be moved towards the gear wheel by operating the linear actuator (comprising, for example, a screw and a slide coupled thereto).

### BRIEF DESCRIPTION OF THE DRAWINGS

Further objects and advantages of the present invention will become apparent from the following detailed description of embodiments thereof and from the accompanying drawings, given by mere way of non-limiting example, in which:

FIG. 1 shows, in a diagrammatic perspective view, a tuner according to the present invention;

FIG. 2 shows the tuner of FIG. 1 partially exploded.

### DETAILED DESCRIPTION OF SOME PREFERRED EMBODIMENTS OF THE INVENTION

Hereinafter in the present description, a figure may be illustrated also with reference to elements not expressly indicated therein but indicated on other figures instead. The scale and proportions of the various depicted elements do not necessarily correspond to the real ones.

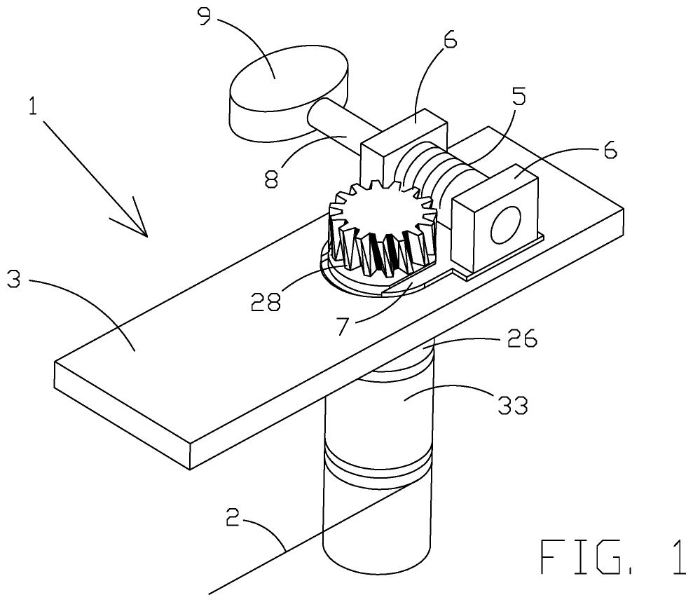

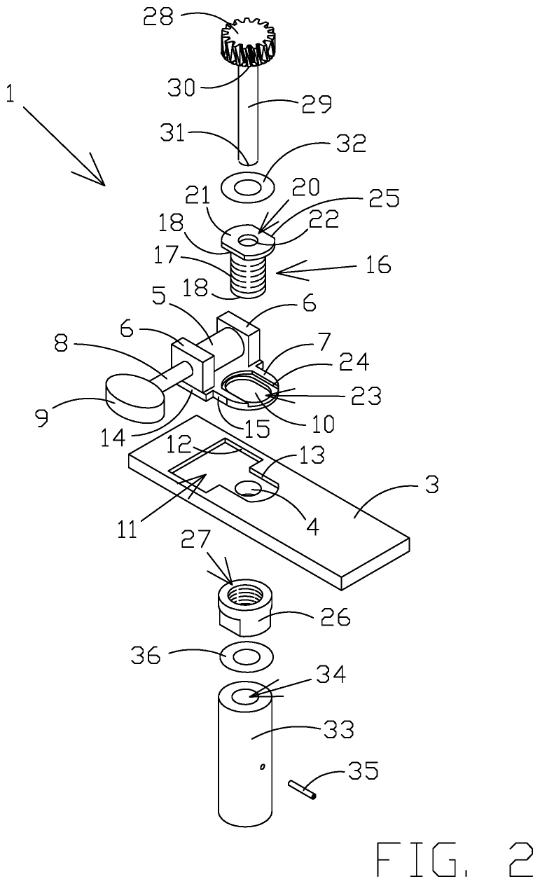

FIGS. 1 and 2 show a tuner 1, object of the invention, for tensioning a string 2 of a musical instrument of the “plucked chordophone” type.

The tuner 1 comprises a small slab 3 acting as a support structure and commonly known as “plate”. The latter, previously identified with the expression “first support structure”, may be connected to the neck of the musical instrument of which the string 2 is part, at an end portion of said neck commonly known as “headstock”. As it may be seen in FIG. 2, the plate 3 comprises a through hole 4 preferably circular and preferably obtained in an almost central position. The hole 4 was previously identified as the “first hole”.

The tuner 1 further comprises an involute screw 5 interposed between two shoulders 6 through which the screw 5 is connected to a second small slab 7, also acting as a support structure and in turn connected to the slab 3, preferably parallel to the latter. The slab 7 was previously identified with the expression “second support structure”. The shoulders 6 are preferably mutually parallel and orthogonal to the slab 7. The screw 5 is connected, by means of the shoulders 6, to the slab 7 so as to be forced to rotate, with respect to the latter, about a first axis coincident with the longitudinal axis of the screw 5. Said first axis is preferably parallel to the slab 7 (and therefore also to the plate 3) and more preferably orthogonal to the shoulders 6. The screw 5 is connected, by means of a shaft 8 preferably coaxial thereto and “exiting” from one of the shoulders 6, to a knob 9 commonly known as a “button”. The latter is integrally connected, by means of the shaft 8, to the screw 5 and is graspable by a person to rotate the screw 5 about the aforesaid first axis. For the avoidance of doubt, the shaft 8, crossing one of the shoulders 6, is connected to the screw 5 at a first end thereof, and is connected to the button 9 at the second end thereof opposite the first end of thereof.

As it may be noticed in FIG. 2, the slab 7 comprises a through hole 10 previously identified as the “third hole”. The hole 10 is preferably obtained at a portion of the slab 7 in front of the screw 5 and is preferably in a central position with respect to the latter. The slab 7 is superimposed on the plate 3 so that the hole 10 communicates with the hole 4. The hole 10 is preferably elongated in shape and is delimited by an edge preferably substantially shaped as the perimeter of a flat geometric figure, consisting of a rectangle and two semicircles each of which having a diameter congruent with a short side of the rectangle, and respectively matching the short sides of said rectangle at the side thereof corresponding to the diameter. Preferably, the diameter of the two aforesaid semicircles is substantially equal to the diameter of the hole 4.

Again, as it may be noticed in FIG. 2, the plate 3 preferably comprises a cavity 11 previously identified with the expression “first seat” and in which the slab 7 is at least partially accommodated. More precisely, the slab 7 is accommodated in the cavity 11 preferably at least at the aforesaid portion of the slab 7 in front of the screw 5 and in which the hole 10 is obtained. More preferably, the slab 7 is completely accommodated in the cavity 11. It is preferably at the cavity 11 that the hole 4 is obtained in the plate 3. The cavity 11 is preferably delimited by a plurality of side walls which preferably rise orthogonally from a bottom. At least two of said side walls, marked with reference numeral 12, are preferably mutually opposite and parallel. More preferably, two other of said side walls, marked with reference numeral 13, are mutually opposite and parallel both to each other and to the walls 12. The hole 4 is preferably interposed between the walls 13. The walls 12 are therefore preferably in a rearward position with respect to the hole 4.

Similarly to the cavity 11, the slab 7 preferably comprises (i.e., it is preferably delimited by) a plurality of side walls. At least two of said side walls of the slab 7, marked with reference numeral 14, are preferably mutually opposite and parallel. More preferably, two other of said side walls of the slab 7, marked with reference numeral 15, are mutually opposite and parallel both to each other and to the walls 14. The walls 14 and 15 are orthogonal to the previously mentioned first axis (for the rotation of the screw 5).

The slab 7 is accommodated in the cavity 11 so that the walls 14 are respectively opposite to and in contact with the walls 11, and the walls 15 are respectively opposite to and in contact with the walls 12. The walls 12, 13, 14 and 15 are therefore mutually parallel. Furthermore, the walls 12 and 13 are also orthogonal to the previously mentioned first axis (for the rotation of the screw 5). The cavity 11 is more extended than the slab 7 and, more precisely, each of the walls 12 and 13 is longer than the wall 14 or 15 to which it is opposite and with which it is in contact. In particular, the slab 7 and the cavity 11 are shaped so that the slab 7, due to the effect of said at least partial accommodation in the cavity 11, is forced to translate, with respect to the plate 3 parallel to the walls 12, 13, 14 and 15 and therefore orthogonally to the previously mentioned first axis (for the rotation of the screw 5). The cavity 11 therefore acts, with respect to the slab 7, not only as an at least partial accommodation seat, but also as a linear guide with respect to the plate 3.

The hole 10 communicates with the hole 4 regardless of the “translatability” of the slab 7 into the cavity 11, i.e., regardless of the position occupied by the slab 7 in the cavity 11 as imposed by the walls 12, 13, 14 and 15. Preferably, when the slab 7 is at one or the other end-of-stroke, one or the other segment of the delimiting edge of the hole 10 corresponding to a semicircumference (in light of the preferable and previously described conformation of the of the hole 10) preferably overlaps a segment of the delimiting edge of the hole 4 which also corresponds to a semicircle. Preferably, the segments of the delimiting edge of the hole 10, respectively corresponding to the long sides of the previously mentioned rectangle, are parallel to the walls 14 and 15.

The tuner 1 comprises a flanged and externally threaded bush 16. The bush 16 includes an externally threaded tubular cylindrical side wall 17 extending from a first end 18 to a second end 19 opposite to said first end 18. The wall 17 delimits a cavity 20 accessible through a first opening at the end 18 and a second opening at the end 19. Said first and second openings, as well as the ends 18 and 19, are opposite to each other. The cavity 20 was previously identified with the expression “first cavity”. The bush 16 comprises a flange 21 including a preferably circular through hole 22 previously identified with the expression “second hole”. The flange 21 is connected to the wall 17, preferably orthogonally to the latter and at the end 18, so that the hole 22 communicates with the aforesaid first opening, so that the cavity 20 is accessible from the hole 22.

The wall 17 has a length (understood as the distance between the ends 18 and 19) greater than the sum between the depth of the hole 4 and the depth of the hole 10. The wall 17 crosses the slab 7 at the hole 10 and the plate 3 at the hole 4, so as to be partially accommodated in the holes 4 and 10. Unlike the wall 17, the flange 21 is of such a size and/or has such a shape such as not to penetrate into the hole 10, nor into the hole 4. The bush 16 therefore crosses the slab 7 and the plate 3 exclusively at the wall 17. The fact that, as previously mentioned, the hole 10 communicates with the hole 4 regardless of the “translatability” of the slab 7 in the cavity 11, therefore means that the slab 7 is translatable with respect to the plate 3 even though it is crossed by the bush 16. Preferably, the wall 17 is orthogonal to the plate 3, the longitudinal axis of the wall 17 is orthogonal to the previously mentioned first axis (for the rotation of the screw 5) and the hole 4 is of such a size to allow a translation of the bush 16 only orthogonally to the plate 3 and consequently to the previously mentioned first axis (for the rotation of the screw 5).

The flange 21 abuts against the slab 7, i.e., against the plate 3 with the interposition of the slab 7. The latter is therefore partially interposed between the flange 21 and the plate 3. The flange 21 and the slab 7, together with the screw 5, lie on the same side with respect to the plate 3. In light of the foregoing, the flange 21 and the end 19 of the wall 17 lie on opposite sides both with respect to the plate 3 as well as with respect to the slab 7. In addition thereto, since the wall 17 has a length greater than the sum between the depth of the hole 4 and the depth of the hole 10, and since the flange 21 abuts against the plate 3 with the interposition of the slab 7, the wall 17 protrudes for a segment thereof from the plate 3 on the opposite side with respect to the flange 21.

As it may be noticed in FIG. 2, in addition or alternatively to the cavity 11 (in the plate 3), the slab 7, at the previously mentioned portion thereof in which the hole 10 is obtained, preferably comprises a cavity 23 previously identified with the expression “second seat” and in which the flange 21 is at least partially accommodated. Preferably, the flange 21 is completely accommodated in the cavity 23. Incidentally and in light of the foregoing, the hole 10 is preferably obtained in the slab 7 at the cavity 23. The latter is preferably delimited by a plurality of side walls which preferably rise orthogonally from a bottom. At least two of said side walls, marked with reference numeral 24, are preferably mutually opposite and parallel both to each other and to the walls 14 and 15. As well as the walls 14 and 15, the walls 24 are also orthogonal to the previously mentioned first axis (for the rotation of the screw 5). The hole 10 is preferably interposed between the walls 24.

Similarly to the cavity 23, the flange 21 preferably comprises (i.e., it is preferably delimited by) a plurality of side walls. At least two of said side walls of the flange 21, marked with numeral 25, are preferably mutually opposite and parallel, and preferably orthogonal to the longitudinal axis of the wall 17. The flange 21 is accommodated in the cavity 23 so that the walls 25 are respectively opposite to and in contact with the walls 24. The walls 24 and 25 are therefore parallel both to each other and to the walls 12, 13, 14 and 15. The walls 24 and 25 are also orthogonal to the previously mentioned first axis (for the rotation of the screw 5). The cavity 23 is more extended than the flange 21 and, more precisely, each of the walls 24 is longer than the wall 25 to which it is opposite and with which it is in contact. In particular, the flange 21 and the cavity 23 are shaped so that, since the hole 4 is preferably of such a size to allow a translation of the bush 16 only orthogonally to the plate 3, the slab 7, due to the effect of said at least partial accommodation of the flange 21 in the cavity 23, is forced to translate, with respect to the plate 3, parallel to the walls 24 and 25 (and also to the walls 12, 13, 14 and 15) and therefore orthogonally to the previously mentioned first axis (for the rotation of the screw 5). As well as the cavity 11, the cavity 23 therefore acts not only as an at least partial accommodation seat for the flange 21, but also, with respect to the slab 7, as a linear guide with respect to the plate 3. The cavities 11 and 23, if both present, force the slab 7 to translate with respect to the plate 3 in the same direction (orthogonal to the previously mentioned first rotation axis of the screw 5) and preferably for the same width. Incidentally, the segments of the delimiting edge of the hole 10, respectively corresponding to the long sides of the aforesaid rectangle, are preferably also parallel to the walls 24.

The tuner 1 comprises a nut 26 previously identified with the expression “first tightening element” and including a threaded cavity 27. The nut 26, at the cavity 27, previously identified with the expression “second cavity”, is reversibly screwable on the wall 17 starting from the end 19 of the latter. More precisely, the nut 26 is reversibly screwed on the wall 17 at the segment thereof protruding from the plate 3. The flange 21 and the nut 26 therefore lie on opposite sides with respect to the plate 3 and the slab 7. The nut 26 is screwed on the wall 17 so as to abut against the plate 3 so as to determine a tightening of the slab 7 and of the plate 3 between the flange 21 and the nut 26, and, more precisely, both a tightening of the slab 7 between the flange 21 and the plate 3, as well as a tightening of the plate 3 between the slab 7 and the nut 26. Said tightenings integrally connect both the slab 7 and the bush 16 to the plate 3.

The wall 17 has a length such that a portion of the previously mentioned segment of the wall 17 protruding from the plate 3 protrudes beyond the nut 26. The wall 17 thus has a length greater than the sum of the depth of the hole 10, the depth of the hole 4 and the depth of the cavity 27 (of the nut 26).

Incidentally, since the slab 7 overlaps the plate 3 (and is at least partially accommodated in the cavity 11) so that the hole 10 communicates with the hole 4 regardless of the “translatability” of the slab 7 with respect to the plate 3, the hole 4 and the cavity 27 are accessible from the hole 10 regardless of the “translatability” of the slab 7 with respect to the plate 3.

The tuner 1 comprises a helical cylindrical gear wheel 28 and a stem 29 including a first end 30 and a second end 31 opposite the end 30. The stem 29 is integrally connected to the wheel 28 at the end 30, preferably orthogonally, i.e., so that a longitudinal axis of the stem 29 coincides with the rotation axis of the wheel 28 (i.e., an axis orthogonal to the latter and crossing the center thereof if the wheel 28 was outlined with a circle). The stem 29 has a length (understood as the distance between the ends 30 and 31) greater than that of the wall 17 and crosses the bush 16 at the hole 22 (of the flange 21) and of the cavity 20, so as to be partially accommodated in the latter. The wheel 28 is of such a size and/or has such a shape to not penetrate into the hole 22, nor, preferably, into the cavity 20. The wheel 28 also abuts against the flange 21 directly or, preferably, with the interposition of a washer 32, preferably a metal one, so as to protect the wheel 28 and the flange 21 from wear due to rubbing. The wheel 28 and the end 31 of the stem 29 therefore lie on opposite sides with respect to the slab 7 and the plate 3. Similarly, the wheel 28 and the nut 26 lie on opposite sides with respect to the slab 7 and the plate 3. Conversely, the screw 5 and the wheel 28 lie on the same side with respect to the slab 7 and the plate 3. Since the stem 29 has a length greater than that of the wall 17, the stem 29 protrudes for a segment thereof from the bush 16, and more precisely from the end 19 of the wall 17 (i.e., from the opposite side with respect to the flange 21).

The stem 29 is accommodated in the cavity 20 so as to be forced to rotate, with respect to the bush 16 (and consequently with respect to the plate 3 and to the slab 7), about a second axis coincident with the longitudinal axis of the wall 17 and with the above mentioned longitudinal axis of the stem 29 (and consequently with the rotation axis of the wheel 28), and orthogonal to the previously mentioned first axis (for the rotation of the screw 5). Incidentally, the aforesaid first and second axes are not coplanar. Asserting that said first and second axes are mutually orthogonal means that if one of said two axes was made to translate with respect to the other one of said two axes so as to make them intersect, they would be coplanar and orthogonal. Again incidentally, since the hole 4 is preferably of such a size to allow a translation of the bush 16 only orthogonally to the plate 3, the hole 4 is preferably of such a size to allow a translation of the bush 16 only parallel to said second axis.

The previously mentioned “same direction” in which both the cavity 11 and the cavity 23 force the slab 7 to translate with respect to the plate 3, is orthogonal not only to the aforesaid first axis (for the rotation of the screw 5), but also to the aforesaid second axis (for the rotation of wheel 28).

The tuner 1 comprises a roller 33 known as “string winder” previously identified with the expression “second tightening element” and including a cavity 34 extending longitudinally in the roller 33 for the entire length thereof. The roller 33, at the cavity 34, is fitted on the previously mentioned segment of the stem 29 protruding from the bush 16. In other words, the segment of the stem 29 protruding from the bush 16 is at least partially accommodated in the cavity 34 (previously identified with the expression “third cavity”).

The roller 33 is integrally, and preferably reversibly, connected to the stem 29. Said connection preferably occurs by means of a pin 35 inserted into the roller 33 up to the stem 29. The roller 33 is connected to the stem 29 so as to abut against the bush 16, directly or, preferably, with the interposition of a washer 36, preferably a metal one, so as to protect the bush 16 and the roller 33 from wear due to rubbing, at the end 19 of the wall 17, so as to prevent a translation of the stem 29, together with the wheel 28, with respect to the bush 16 (i.e., parallel to the previously mentioned second axis).

The screw 5 and the wheel 28 are connected to the plate 3 (by means of the slab 7 and of the bush 16, respectively) so that one meshes with the other, so that a rotation of the screw 5 about the previously mentioned first axis causes a rotation of the wheel 28, together with the stem 29 and the roller 33, about the previously mentioned second axis. The string 2 is preferably reversibly connectable to the roller 33 so that, when the string 2 is connected to the roller 33 (as shown in FIG. 1), a rotation of the roller 33 about the aforesaid second axis may tension the string 2.

The seat 11 and the slab 7, or the portion thereof accommodated in the seat 11, are shaped so that the slab 7, together with the screw 5, is forced to translate with respect to the plate 3 so that the screw 5 translates (i.e., “is forced to translate”) towards or away from the wheel 28 orthogonally to the aforesaid first and second axes.

Similarly, the seat 23 and the slab 21, or the portion thereof accommodated in the seat 23, are shaped so that the slab 7, together with the screw 5, is forced to translate with respect to the plate 3 so that the screw 5 translates (i.e., “is forced to translate”) towards or away from the wheel 28 orthogonally to the aforesaid first and second axes.

The seats 11 and 23 therefore both act as linear guiding means forcing the slab 7, together with the screw 5, to translate with respect to the plate 3 so that the screw 5 translates (i.e., “is forced to translate”) towards or away from the wheel 28 orthogonally to the aforesaid first and second axes so that, whenever a play is undesirably present between the screw 5 and the wheel 28:
following an unscrewing of the nut 26 from the wall 17, so as to loosen the tightening of the slab 7 between the flange 21 and the plate 3, the screw 5 is translatable towards the wheel 28, in accordance with (i.e., “as required by”) the aforesaid guiding means, so as to eliminate said play, and
after eliminating said play, the slab 7 is integrally reconnectable to the plate 3 by screwing the nut 26 onto the wall 17 so that the nut 26 returns to abut against the plate 3, redetermining the tightening of the slab 7 between the flange 21 and the plate 3.

Incidentally, for the slab 7, together with the screw 5, to be forced to translate with respect to the plate 3 so that the screw 5 translates (i.e., “is forced to translate”) towards or away from the wheel 28 orthogonally to the aforesaid first and second axes, it is sufficient that the tuner 1 comprises only the seat 11 or only the seat 23 shaped, together with the slab 7 and the flange 21, respectively, according to what has been previously said.

Again incidentally, the seats 11 and 23 constitute only an example of linear guiding means of the slab 7 with respect to the plate 3. The slab 7, together with the screw 5, may be forced to translate with respect to the plate 3 so that the screw 5 translates (i.e., “is forced to translate”) towards or away from the wheel 28 orthogonally to the aforesaid first and second axes by means of other known linear guiding systems, preferably sliding ones.

Incidentally, the nut 26 is unscrewable from the wall 17 until it abuts against the roller 33 (or the washer 36, if present). The nut 26 is thus unscrewable from the wall 17 without having to remove the roller 33 from the stem 29 by virtue of the fact that the roller 33 abuts against the bush 16 and the latter has a length greater than the sum of the depth of the hole 4, the depth of the hole 10 and the depth of the cavity 27, so as to protrude beyond the nut 26.

In light of the foregoing, so as to allow the restoring of the play possibly and undesirably present between the screw 5 and the wheel 28, the slab 7 is integrally, but also reversibly, connected to the plate 3.

In light of the features listed above, the tuner 1 allows to eliminate the play possibly present between the wheel 28 and the screw 5 without having to rotate the latter, but moving the screw 5 towards the wheel 28.

According to a variant of the tuner 1, the latter preferably comprises a helical spring, or a known elastic means equivalent thereto, at least partially interposed between the plate 3 and the slab 7 so as to exert a force tending to cause the translation of the slab 7, in accordance with the previously mentioned guiding means, with respect to the plate 3, moving the screw 5 towards the wheel 28 (i.e., so as to make them closer).

In addition or alternatively to the aforesaid elastic means, the tuner 1 may comprise a linear actuator which may be operated if necessary by a person and is integrally connected to the plate 3 and to the slab 7 so as to exert a force tending to cause the translation of the slab 7, in accordance with the previously mentioned guiding means, with respect to the plate 3, moving the screw 5 towards the wheel 28 (i.e., so as to make them closer).

Based on the description given for a preferred embodiment, it is obvious that changes may be introduced by those skilled in the art without departing from the scope of the invention as defined by the following claims.

1. A tuner for tensioning a string of a plucked chordophone musical instrument,
said tuner comprising:
a first support structure connectable to a neck of said musical instrument,
said first support structure including a first through hole;
an involute screw;
a second support structure connected to said first support structure,
said involute screw being connected to said second support structure so as to be forced to rotate, with respect to said second support structure, about a first axis coincident with a longitudinal axis of said involute screw;
a knob integrally connected to said involute screw,
said knob being graspable by a person to rotate said involute screw about said first axis;
a bush including:
a tubular side wall, externally threaded and extending from a first end to a second end opposite to said first end;
a first cavity delimited by said tubular side wall;
a first opening to access said first cavity,
said first opening being at said first end;
a second opening to access said first cavity,
said second opening being opposite to said first opening and being at said second end;
a flange comprising a second through hole,
said flange being connected to said tubular side wall at said first end so that said second hole communicates with said first opening so that said first cavity is also accessible from said second hole,
said tubular side wall having a length greater than the depth of said first hole and crossing said first support structure at said first hole, so as to be partially accommodated in said first hole,
said flange being of such a size and/or having such a shape to penetrate into said first hole,
said flange abutting against said first support structure so that:
said flange and said second end lie on opposite sides with respect to said first support structure
and
said tubular side wall protrudes, for a segment thereof, from said first support structure on the opposite side with respect to said flange,
said flange and said second support structure, together with said involute screw, lying on the same side with respect to said first support structure;
a first tightening element including a second threaded cavity at which said first tightening element is reversibly screwable on said tubular side wall starting from said second end,
said first tightening element being reversibly screwed on said tubular side wall at said segment thereof protruding from said first support structure, so as to abut against said first support structure, so as to determine a tightening of said first support structure between said flange and said first tightening element,
said tubular side wall having a length such that a portion of said segment of said tubular side wall protruding from said first support structure protrudes beyond said first tightening element,
said tightening of said first support structure between said flange and said first tightening element integrally connecting said bush to said first support structure;
a helical cylindrical gear wheel;
a stem including a first end and a second end opposite to said first end of said stem,
said stem being integrally connected to said gear wheel at the first end thereof so that a longitudinal axis of said stem coincides with a rotation axis of said gear wheel, said stem having a length greater than that of said tubular side wall and crossing said bush at said second hole and at said first cavity, so as to be partially accommodated in said first cavity,
said gear wheel being of such a size and/or having such a shape to not penetrate into said second hole,
said gear wheel abutting against said flange so that:
said gear wheel and said second end of said stem lie on opposite sides with respect to said first support structure
and
said stem protrudes for a segment thereof from said second end of said tubular side wall,
said stem being accommodated in said first cavity so as to be forced to rotate, with respect to said bush, about a second axis coincident with said longitudinal axis of said stem and orthogonal to said first axis;
a second tightening element including a third cavity in which said segment of said stem protruding from said bush is at least partially accommodated,
said second tightening element being integrally connected to said stem so as to abut against said bush at said second end of said tubular side wall, so as to prevent any translation between said stem, together with said gear wheel, and said bush, said involute screw and said gear wheel being connected to said first support structure by means of said second support structure and said bush, respectively, so that said involute screw meshes with said gear wheel so that a rotation of said involute screw about said first axis determines a rotation of said gear wheel, together with said stem and said second tightening element, about said second axis,
said string being connectable to said second tightening element so that, when said string is connected to said second tightening element, a rotation of said second tightening element about said second axis may tension said string,
wherein said second support structure comprises a third through hole,
said second support structure overlapping said first support structure so that said third hole communicates with said first hole, so that said first hole and said second cavity are accessible from said third hole,
said third hole having such a width such and/or such a conformation that said second support structure may be crossed, at said third hole, by said tubular side wall but not by said flange,
said tubular side wall having a length greater than the sum of the depth of said first hole, the depth of said third hole and the depth of said second cavity,
said tubular side wall crossing not only said first support structure at said first hole, but also said second support structure at said third hole, so as to be partially accommodated also in said third hole,
said flange abutting against said first support structure with the interposition of said second support structure so that:
said flange and said second end of said tubular side wall lie on opposite sides not only with respect to said first support structure but also with respect to said second support structure
and
the fact that said first tightening element is reversibly screwed on said tubular side wall so as to abut against said first support structure determines a tightening of said second support structure between said flange and said first support structure,
said tightening of said second support structure between said flange and said first support structure integrally connecting said second support structure to said first support structure,
said tuner comprising linear guiding means forcing said second support structure, together with said involute screw, to translate with respect to said first support structure so that said involute screw translates towards or away from said gear wheel orthogonally to said first and second axis, so that, whenever a play is undesirably present between said involute screw and said gear wheel:
following an unscrewing of said first tightening element from said tubular side wall, so as to loosen said tightening of said second support structure between said flange and said first support structure, said involute screw is translatable towards said gear wheel, in accordance with said guiding means, in order to eliminate said play,
and
after eliminating said play, said second support structure is integrally reconnectable to said first support structure by re-screwing said first tightening element on said tubular side wall so that said first tightening element returns to abut against said first support structure, redetermining said tightening of said second support structure between said flange and said first support structure,
said third hole having such a width and/or such a conformation to be communicating with said first hole regardless of the position of said second support structure with respect to said first support structure according to said guiding means.

2. A tuner according to claim 1, wherein said guiding means comprise a first seat obtained in said first support structure and in which said second support structure is accommodated at least at a portion thereof,
said first seat and said portion of said second support structure accommodated in said first seat being shaped so that said second support structure, together with said involute screw, due to the effect of said at least partial accommodation in said first seat, is forced to translate, with respect to said first support structure, so that said involute screw moves towards, or away from said gear wheel, orthogonally to said first and second axis.

3. The tuner according to claim 2, wherein said first hole is obtained in said first support structure at said first seat, said third hole being obtained in said second support structure at said portion of said second support structure accommodated in said first seat.

4. The tuner according to claim 1, wherein said guiding means comprise a second seat obtained in said second support structure and in which said flange is accommodated at least at a portion thereof,
said second seat and said portion of said flange accommodated in said second seat being shaped so that said second support structure, together with said involute screw, due to the effect of said at least partial accommodation of said flange in said second seat, is forced to translate, with respect to said first support structure, so that said involute screw translates towards, or away from said gear wheel, orthogonally to said first and second axes.

5. The tuner according to claim 1, wherein said first hole is shaped so as to allow a translation of said bush exclusively parallel to said second axis.

6. The tuner according to claim 1, further comprising elastic means at least partially interposed between said first and second support structures so as to exert a force tending to translate said second support structure, in accordance with said guiding means, with respect to said first support structure moving said involute screw close to said gear wheel.

7. The tuner according to claim 1, further comprising a linear actuator integrally connected to said first and second support structures so as to exert a force tending to translate said second support structure, in accordance with said guiding means, with respect to said first support structure moving said involute screw close to said gear wheel,
said actuator being operable by a user of said tuner.

8. The tuner according to claim 2, wherein said guiding means comprise a second seat obtained in said second support structure and in which said flange is accommodated at least at a portion thereof,
said second seat and said portion of said flange accommodated in said second seat being shaped so that said second support structure, together with said involute screw, due to the effect of said at least partial accommodation of said flange in said second seat, is forced to translate, with respect to said first support structure, so that said involute screw translates towards, or away from said gear wheel, orthogonally to said first and second axes.

9. The tuner according to claim 3, wherein said guiding means comprise a second seat obtained in said second support structure and in which said flange is accommodated at least at a portion thereof,
said second seat and said portion of said flange accommodated in said second seat being shaped so that said second support structure, together with said involute screw, due to the effect of said at least partial accommodation of said flange in said second seat, is forced to translate, with respect to said first support structure, so that said involute screw translates towards, or away from said gear wheel, orthogonally to said first and second axes.

10. The tuner according to claim 2, wherein said first hole is shaped so as to allow a translation of said bush exclusively parallel to said second axis.

11. The tuner according to claim 3, wherein said first hole is shaped so as to allow a translation of said bush exclusively parallel to said second axis.

12. The tuner according to claim 4, wherein said first hole is shaped so as to allow a translation of said bush exclusively parallel to said second axis.

13. The tuner according to claim 8, wherein said first hole is shaped so as to allow a translation of said bush exclusively parallel to said second axis.

14. The tuner according to claim 9, wherein said first hole is shaped so as to allow a translation of said bush exclusively parallel to said second axis.

15. The tuner according to claim 2, further comprising elastic means at least partially interposed between said first and second support structures so as to exert a force tending to translate said second support structure, in accordance with said guiding means, with respect to said first support structure moving said involute screw close to said gear wheel.

16. The tuner according to claim 3, further comprising elastic means at least partially interposed between said first and second support structures so as to exert a force tending to translate said second support structure, in accordance with said guiding means, with respect to said first support structure moving said involute screw close to said gear wheel.

17. The tuner according to claim 4, further comprising elastic means at least partially interposed between said first and second support structures so as to exert a force tending to translate said second support structure, in accordance with said guiding means, with respect to said first support structure moving said involute screw close to said gear wheel.

18. The tuner according to claim 5, further comprising elastic means at least partially interposed between said first and second support structures so as to exert a force tending to translate said second support structure, in accordance with said guiding means, with respect to said first support structure moving said involute screw close to said gear wheel.

19. The tuner according to claim 8, further comprising elastic means at least partially interposed between said first and second support structures so as to exert a force tending to translate said second support structure, in accordance with said guiding means, with respect to said first support structure moving said involute screw close to said gear wheel.

20. The tuner according to claim 9, further comprising elastic means at least partially interposed between said first and second support structures so as to exert a force tending to translate said second support structure, in accordance with said guiding means, with respect to said first support structure moving said involute screw close to said gear wheel.
